(19) United States
(12) Patent Application Publication
(10) Pub. No.: US 2007/0226028 A1
(43) Pub. Date: Sep. 27, 2007

(54) Sharing System Management Responsibility with an Autonomic Manager

(76) Inventors: Kathryn H. Britton, Chapel Hill, NC (US); Nicholas D. Butler, Hampshire (GB); Christine Draper, Basingstoke (GB); Peter J. Brittenham, Pittsboro, NC (US); Brent A. Miller, Cary, NC (US); John W. Sweitzer, Austin, TX (US); Chakkalamattam Jos Paul, Austin, TX (US)

Correspondence Address: MOORE & VAN ALLEN, PLLC For IBM, P.O. Box 13706, Research Triangle Park, NC, 27709, US

(21) Appl. No.: 11/277,397

(22) Filed: Mar. 24, 2006

(51) Int. Cl. G06F 15/16; G06F 9/46

(52) U.S. Cl. 705/8

(57) ABSTRACT

A method to share systems management responsibility may include allowing formation of a manual manager, wherein the manual manager is formable as a manageable resource capable of being monitored and controlled. The method may also include permitting the autonomic manager to be monitored and controlled by the manual manager using a manageability interface of the autonomic manager.

### BACKGROUND OF THE INVENTION

The present invention relates to autonomic computing or the like, and more particularly to a method and system to shift system management responsibility between a human and an autonomic manager.

Autonomic computing technology is based on creating system components referred to as autonomic managers that can perform actions that make systems more self-managing. An autonomic manager may perform a closed autonomic computing loop, such as a monitor-analyze-plan-execute (MAPE) loop or the like. Accordingly, the autonomic computing loop may involve the operations of monitoring a manageable entity, analyzing any data or information received, planning any actions as a result of the analysis and executing the actions. Acceptance of autonomic management will probably be gradual or piecemeal. Functions will most likely be gradually turned over to autonomic management as trust in the ability of such systems to manage themselves grows.

### BRIEF SUMMARY OF THE INVENTION

In accordance with an embodiment of the present invention, a method to share systems management responsibility may include allowing formation of a manual manager, wherein the manual manager is formable as a manageable resource capable of being monitored and controlled. The method may also include permitting the autonomic manager to be monitored and controlled using a manageability interface of the autonomic manager.

In accordance with another embodiment of the present invention, a system to share systems management responsibility may include an interface to selectively perform a portion of autonomic management associated with a manageable entity that is also manageable by an autonomic manager. A manual manager may be formable as a manageable resource capable of being monitored and controlled. The system may also include a manageability interface associated with the autonomic manager to permit the autonomic manager to be monitored and controlled.

In accordance with another embodiment of the present invention, a computer program product to share systems management responsibility may include a computer usable medium having computer usable program code embodied therein. The computer usable medium may include computer usable program code configured to allow formation of a manual manager, wherein the manual manager is formable as a manageable resource capable of being monitored and controlled. The computer usable medium may also include computer usable program code configured to permit the autonomic manager to be monitored and controlled using a manageability interface of the autonomic manager.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an example of a method to share systems management responsibility in accordance with an embodiment of the present invention.

FIG. 2 is a block diagram of an exemplary system to share systems management responsibility in accordance with an embodiment of the present invention.

FIG. 3 is a block diagram of an exemplary system to share systems management responsibility in accordance with another embodiment of the present invention.

FIG. 4 is a block diagram of an exemplary system to share systems management responsibility in accordance with a further embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

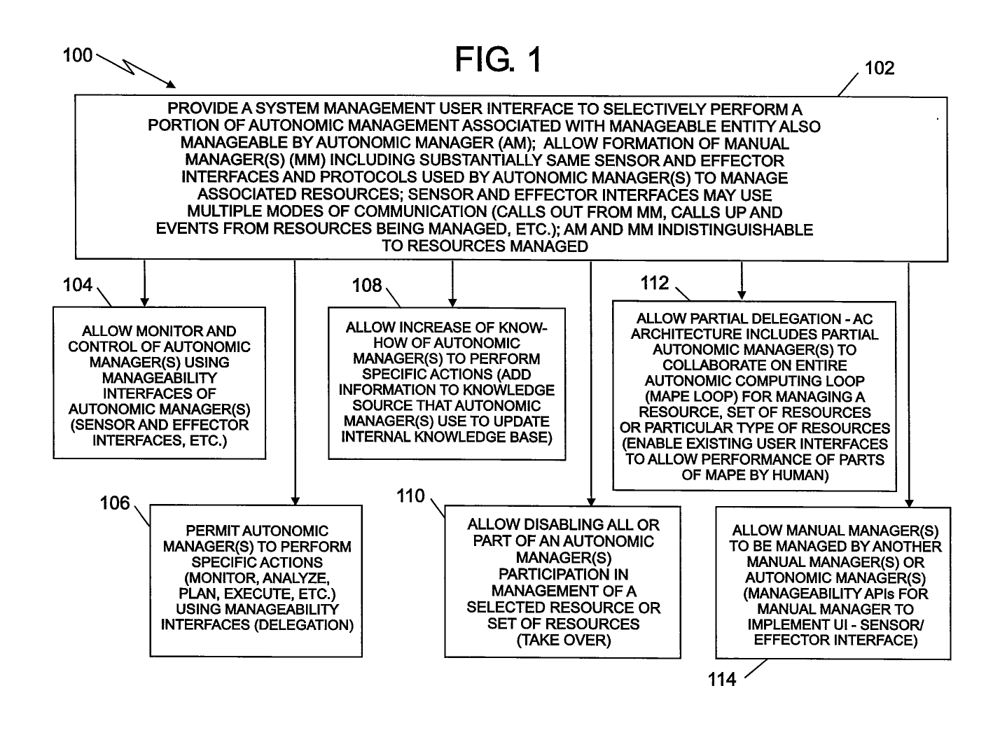

FIG. 1 is a flow chart of an example of a method 100 to share systems management responsibility in accordance with an embodiment of the present invention. In block 102, a systems management user interface may be provided to selectively perform at least a portion of autonomic management associated with a manageable entity that is also manageable by an autonomic manager. Infrastructure may be added to a systems management user interface implementation to allow user participation in the autonomic computing architecture in ways that make the user and/or user interface indistinguishable from an autonomic manager. The user interface may include a model view controller (MVC) or similar architecture. The enabled user interface may be referred to as a manual manager. One advantage to this arrangement is that the same interfaces and system flows can be used for both the manual and autonomic management. This makes achieving a continuously evolving and dynamic state possible that may establish and maintain an optimum balance between what may be done manually and what may be done autonomically, depending upon circumstances, workloads, policies, and other features or demands of a particular business entity or other entity.

As described in more detail herein, block 102 may also include providing an interface, or other means to assign tasks to an autonomic manager; providing means for the autonomic manager to request assistance; providing means to oversee autonomic manager results for quality; providing means to take over tasks performed by the autonomic manager; providing means to participate in complex system management configurations that partly autonomically participate in the autonomic computing architecture; forming a manual manager including a human manager, operator or user together with a user interface or the like, wherein the manual manager may define a manageable resource capable of being monitored and controlled; permitting participation of both the manual manager and the autonomic manager in the autonomic computing architecture, wherein the manual manager and the autonomic manager are adapted to be monitored and controlled using a respective manageability interface of the autonomic manager and the manual manager; or other functions or operations related to systems management. These means may be embodied in code or data structures associated with the autonomic managers and manual managers and/or associated manageability interfaces described herein. Tasks may also be defined as including subtasks or parts of an overall task.

In block 104, an autonomic manager may be monitored and controlled in the autonomic computing architecture using a manageability interface of the autonomic manager. Manual managers may interface with autonomic managers to allow monitoring and controlling the autonomic managers. The manual managers may include substantially the same sensor and effector interfaces and protocols used by the autonomic managers to manage manageable entities, such as a resource or the like. The managed entity or resource is preferably unable to distinguish between a manual manager and an autonomic manager.

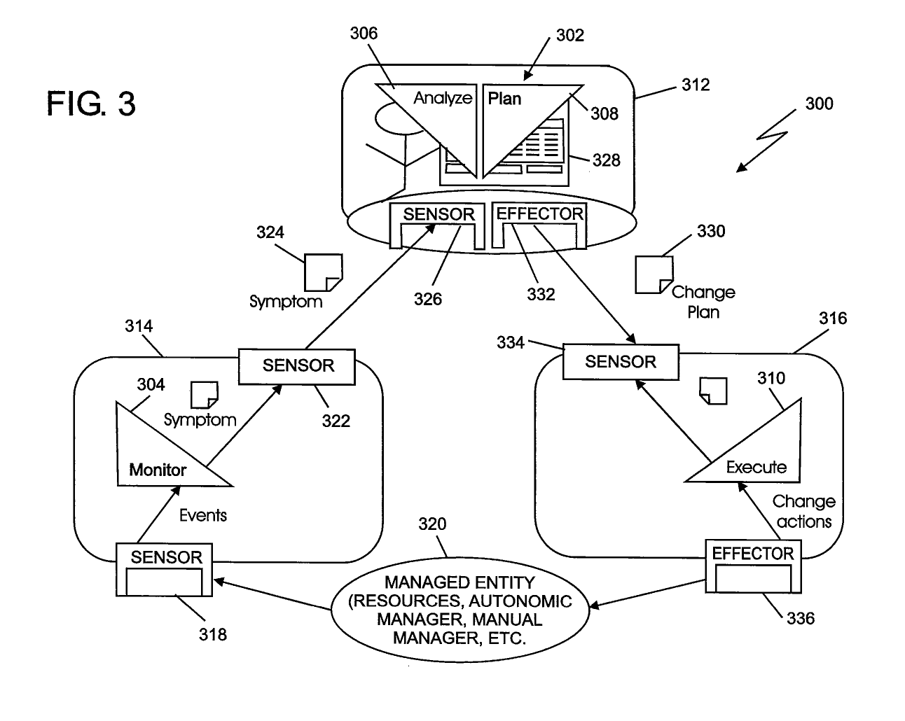

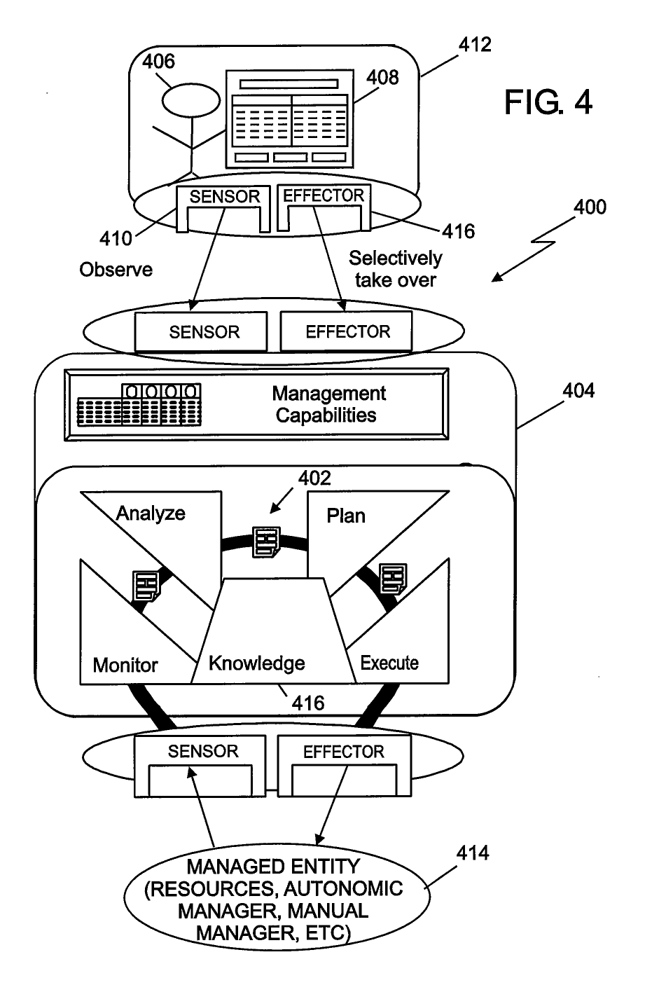

In block 106, an autonomic manager or managers may be permitted to perform a specific action or actions using the manageability interface. This may involve a manual manager delegating selected functions associated with an autonomic computing process to one or more autonomic managers. The autonomic computing process may be an autonomic computing loop, such as a monitoring, analyzing, planning, executing (MAPE) loop or the like. An example of full delegation and partial delegation will be described in more detail with reference to FIGS. 3 and 4 respectively.

In block 108, the know-how of an autonomic manager or managers may be increased to enable the autonomic manager or managers to perform the specific action or actions. Information or data may be added to a knowledge source or the like that the autonomic managers may use to update their internal knowledge base.

In block 110, all or part of an autonomic manager or managers may be disabled from participation in management of a selected manageable entity or resource or set of manageable entities or resources. This may involve the manual manager taking over or taking back certain system management responsibilities. This is the opposite step to delegation in block 106.

In block 112, the management of one or more entities or resources may be partially delegated. Partial delegation may involve a manual manager being associated with or including an autonomic manager or managers to collaborate on an entire autonomic computing process or loop, MAPE loop, or the like for managing an entity or resource, set of entities or resources or a particular type of entity or resource.

In block 114, a manual manager or managers may be managed by another manual manager, autonomic manager or any combination thereof. Manual managers may implement manageability Application Program Interfaces (APIs) that permit them to be managed by other manual managers, autonomic managers or a combination of manual managers and autonomic managers. Similar sensor/effector interfaces may be used to allow integration and manageability, and the appropriate balance between manual management and autonomic management depending upon circumstances, workloads, policies and other parameters may be established, maintained and adjusted.

The method 100 may also allow assignment of a task to an autonomic manager; allow the autonomic manager to request assistance; permit oversight of autonomic manager results; allow a task being performed by the autonomic manager to be taken over; allow participation in a partially autonomic system management configuration; permit participation of the manual manager and the autonomic manager in an autonomic computing architecture, wherein the manual manager and the autonomic manager are adapted to be monitored and controlled using a respective manageability interface of the autonomic manager and the manual manager; and similar functions.

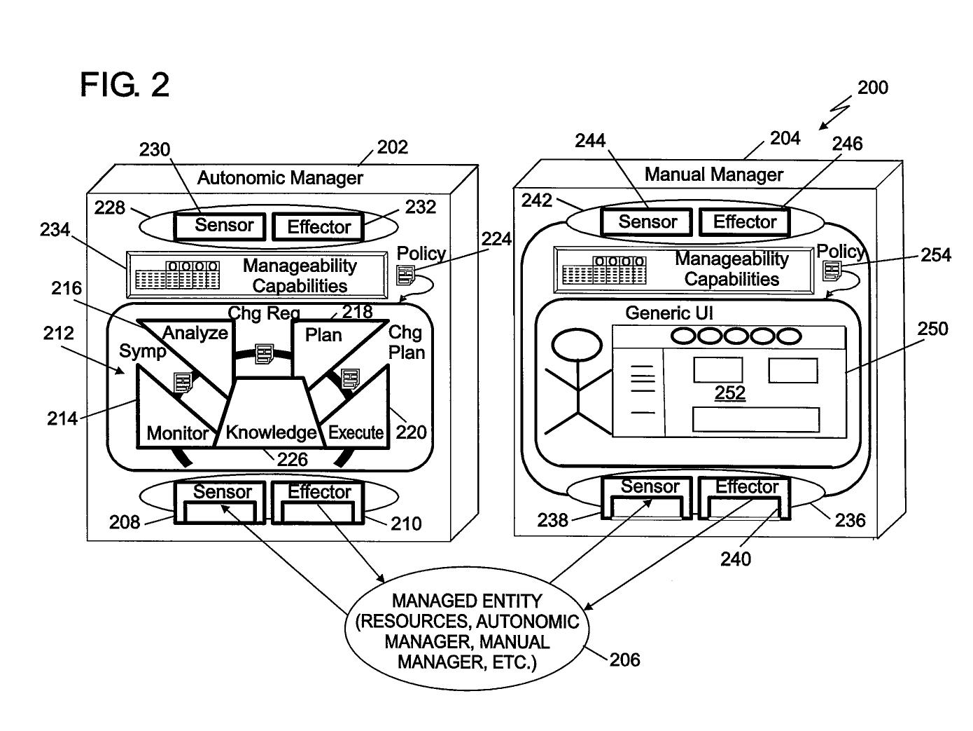

FIG. 2 is a block diagram of an exemplary system 200 to share systems management responsibility in accordance with an embodiment of the present invention. The system 200 may include an autonomic manager 202 and a manual manager 204 that may flexibly share system management responsibility of a managed entity 206. An example of an autonomic manager will be described briefly herein for understanding of the invention and are described in more detail in “An Architectural Blueprint for Autonomic Computing” Third Edition, June 2005, available from the IBM Corporation.

The managed entity 206 may be a resource, set of resources, another autonomic manager or group of autonomic managers, another manual manager or group of manual managers, or any combination of these manageable entities.

The autonomic manager 202 may include the manager side of a sensor interface 208 and an effector interface 210. The sensor interface 208 and effector interface 210 may monitor and control the managed entity 206. The sensor and effector interfaces 208 and 210 may use multiple modes of communication with the managed entity 206 including calls out from the autonomic manager to the managed entity 206, calls up and events from the managed entity 206 and similar modes of communication.

A sensor interface may include two parts. One part may be a set of properties that expose information about the current state of a manageable entity or resource and are accessed through standard “get” operations. Another part of a sensor may include a set of management events, such as unsolicited, asynchronous messages, notifications or the like, that may occur when the manageable entity or resource undergoes a significant state change. These two parts of a sensor interface may be referred to as interaction styles. The “get” operations may use a request-response interaction style. Events may use a send-notification interaction style.

An effector interface may also include two parts. One part may include a collection of “set” operations that allow the state of the manageable entity or resource to be changed in some way. Another part of the effector may include a collection of operations that are implemented by autonomic managers (or manual managers) that allow the manageable resources to make requests from an associated manager. These two parts of a sensor interface may be referred to as interaction styles. The “set” operations may use a perform-operation interaction style. Requests may use a solicit-response interaction style to allow the manageable entity to consult with the associated manager.

The autonomic manager 202 may also include an autonomic computing loop 212, MAPE loop or process. The autonomic computing loop 212 may include a monitor function or module 214, an analyze function or module 216, a plan function or module 218 and an execute function or module 220.

The monitor function 214 may provide mechanisms that collect, aggregate, filter, correlate and report details, such as metrics, topologies or the like collected from the manageable entity 206.

The analyze function 216 may provide mechanisms that model complex situations, for example, time-series forecasting, queuing models or other models of situations. The analyze function may use policy information 224 as a guide. These analyze mechanisms allow the autonomic manager 202 to learn about the environment and help predict future situations.

The plan function 218 may provide mechanisms that construct the actions needed to achieve goals and objectives. The execute function 220 may provide the mechanisms that control the execution of a plan, which may involve executing operations on the managed entity 206. These four parts 214-220 work together to provide the control loop functionality.

The four parts 214-220 communicate and collaborate with one another and exchange appropriate knowledge and data. The four parts may store and acquire knowledge or data from a knowledge base 226.

As previously discussed, the autonomic manager 202 may also include a manageability interface or interfaces 228. The manageability interface 228 may include a sensor interface 230 and an effector interface 232. The sensor interface 230 and effector interface 232 may be substantially the same as the sensor and effector interfaces on a managed resource. The manageability interface 228 may permit other autonomic managers and other components in the system 200 or distributed infrastructure to use the autonomic manager 202. Using manageability interfaces for the system or distributed infrastructure components enables these components to be composed together in a manner that is transparent to the manageable entities. For example, an orchestrating autonomic manager can use the manageability interfaces of touchpoint autonomic managers to accomplish its management functions.

As previously described, even though an autonomic manager may be capable of automating the monitor, analyze, plan and execute parts of an autonomic computing loop, information technology (IT) professionals or the like can configure the autonomic manager to perform only part of its automated function. As described in more detail with respect to FIG. 3, an administrator might configure an autonomic manager to perform only the monitoring function. As a result, the autonomic manager would surface notifications to a common console for the situations or symptoms that it recognizes, rather than automating the analysis, planning and execution functions associated with those actions. Other configurations could allow additional parts of the control loop to be automated.

The autonomic manager 202 may also include a manageability capabilities function or module 234. The manageability capabilities 234 may refer to a logical collection of manageable resource state information and operations. Examples of manageability capabilities 234 may include: identification—state information and operations used to identify an instance of a manageable resource; metrics—state information and operations for measurements of a manageable resource, such as throughput, utilization and so on; configuration—state information and operations for the configurable attributes of a manageable resource; and similar capabilities. The manageability capabilities function 234 is linked to the sensor and effector interfaces 230 and 232. For each manageability capability 234, a client of the manageability interface 228 may be able to obtain and control state data through the manageability interface 228, including: meta details (for example, to identify properties that are used for configuration of a manageable resource, or information that specifies which resources can be hosted by the manageable resource); sensor interactions, including mechanisms for retrieving the current property values (e.g., metrics, configuration) and available notifications (what types of events and situations the manageable resource can generate); or effector interactions, including operations to change the state (which effector operations and interaction styles the manageable resource supports) and call-outs to request changes to an existing state (what types of call-outs the manageable resource can perform).

The manual manager 204 may include a manageability interface 236. The manageability interface 236 may include a sensor interface 238 and an effector interface 240 that may be substantially the same as the autonomic manager sensor interface 208 and effector interface 210. The manual manager may also include a second manageability interface 242. The second manageability interface 242 may also include a sensor interface 244 and an effector interface 246 which may be substantially the same as the other sensor interface 230 and effector interface 232 on the autonomic manager (and sensor and effector interfaces on manageable entities). The sensor interface 244 and effector interface 246 permit the manual manager 204 to be controlled by another manual manager, autonomic manager or a combination of both. As previously discussed, the sensor interfaces and effector interfaces being substantially the same permits the same system flows and protocols to be used and provide a continuously evolving and dynamic system that may establish the right balance between what may done manually and what may beautonomically, depending upon an evaluation of circumstances, workloads, policies and other parameters, as systems management responsibilities may be shifted to an autonomic computing architecture.

The manual manager 204 may also include manageability capabilities 248 link to the sensor and effector interfaces 244 and 246 similar to that previously described.

The manual manager 204 may further include a user interface 250. The user interface 250 may be any type of interface, such as an integrated solutions console (ISC) 250 or similar module. The user interface 250 may include or may be adapted to present reusable user interface (UI) components 252, portlets or the like for performing different functions, such as monitoring and controlling manageable entities 206, delegation of selected responsibilities, oversight, taking back control of selected functions or other operations. The user interface 250 or reusable Ul components 252 may be presented to a user on a display. The user interface 250 may receive policies 254 to allow performing the different functions or operations.

FIG. 3 is a block diagram of an exemplary system 300 to share systems management responsibility in accordance with an embodiment of the present invention. FIG. 3 illustrates an example of partial delegation similar to that described with reference to block 112 in FIG. 1. In partial delegation, a single autonomic computing loop 302 or a monitor 304—analyze 306—plan 308—execute 310 (MAPE) loop can be performed partly by a human via a manual manager 312 and partly by one or more autonomic managers 314 and 316 or partial autonomic managers. In the example of FIG. 3, one partial autonomic manager 314 may perform the monitor function 304. A first manager sensor interface 318 may detect or sense an event or events or receive information relative to an event or events associated with a managed entity or entities 320. A second sensor interface 322 may pass the results or symptoms 324 to a manager sensor interface 326 of the manual manager 312.

A human administrator or the like may then perform the analysis 306 and plan 308 functions via the manual manager's user interface or ISC 328. A change plan 330 or other results from the analyze 306 and plan 308 functions may be sent to the other partial autonomic manager 316. The change plan 330 may be sent from an effector interface 332 of the manual manager 312 to an effector interface 334 of the other partial autonomic manager 316. The execute function 310 may then perform the change actions. The change actions may be transmitted to the managed entity 320 from a second effector interface 336 of the second partial autonomic manager 316.

Accordingly, the administrator or similar user at the user interface or manual manager 312 has delegated the monitor 304 and execute 310 functions to autonomic managers 314 and 316, respectively, and retained the analysis 306 and plan 308 functions for the administrator to perform. In other embodiments of the present invention, the administrator via a manual manager could delegate any combination of the MAPE loop or similar autonomic computing loop or process to other autonomic managers, manual managers or a combination thereof.

FIG. 4 is a block diagram of an exemplary system 400 to share systems management responsibility in accordance with a further embodiment of the present invention. FIG. 4 is an example of full or complete delegation similar to that described with respect to method 100 of FIG. 1. In the example, the autonomic computing loop or MAPE loop 402 has been substantially completely delegated to an autonomic manager 404. A user or administrator 406 may observe what the autonomic manager 404 does via a user interface or ISC 408 and manager sensor interface 410 of a manual manager 412. Examples of information that the user 406 may observe via the user interface 408 may include but is not necessarily limited to statistics about recognized events or symptoms; plans generated to deal with symptoms; outcome of execution functions, such as success, failure, time required or other parameters, data, etc.; or other information related to operation of the autonomic manager 404 in monitoring and controlling a managed entity or entities 414.

The administrator or user 406 may selectively take back control of some or all activities or functions via a manager effector interface 416 in communication with an effector interface 418 of the autonomic manager 404. One example of an activity that may be selectively taken over may include events that may require additional human pattern matching ability to determine the symptoms they may represent. The human response may then become part of the autonomic manager's knowledge 416. Another example of an activity that may be selectively taken back may include retaining ability to require the autonomic manager 404 to present plans for approval before being executed by the autonomic manager 404.

As indicated by the preceding, manual managers of the present invention may allow and enable progression toward adoption of autonomic computing (AC). Manual managers may increase AC activity by being interchangeable with autonomic managers. Manual managers may delegate AC loop activities, provide oversight and take back control if need be. Human activity may be a source of aspects to be made autonomic and delegated to an autonomic manager along with the appropriate knowledge.

Manual managers enable a broadening scope of IT systems management by being able to be composed in a single console. The manual managers may be rearranged to allow user interface elements from different resource types to be composed into single tasks, such as on the same ISC page, UI component or portlet. Collections of resources and/or business operations may be managed rather than separate resources.

Additionally, manual managers can organize management user interfaces to match IT service flows. Work flow technologies may be used to present different tasks to different types of administrators or autonomic managers. This may facilitate independent adoption of AC in different service flows.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method to share systems management responsibility, the method comprising:
allowing formation of a manual manager, wherein the manual manager is formable as a manageable resource capable of being monitored and controlled; and
permitting an autonomic manager to be monitored and controlled using a manageability interface of the autonomic manager.

2. The method of claim 1, further comprising at least one of:
allowing assignment of a task to the autonomic manager;
allowing the autonomic manager to request assistance;
permitting oversight of autonomic manager results;
allowing a task being performed by the autonomic manager to be taken over;
allowing participation in a partially autonomic system management configuration; and
permitting participation of the manual manager and the autonomic manager in an autonomic computing architecture, wherein the manual manager and the autonomic manager are adapted to be monitored and controlled using a respective manageability interface of the autonomic manager and the manual manager.

3. The method of claim 1, wherein permitting the autonomic manager to be monitored and controlled comprises using a sensor interface and an effector interface of the autonomic manager that are substantially identical to a sensor interface and an effector interface of a manageable entity.

4. The method of claim 1, wherein allowing formation of the manual manager comprises providing an interface to selectively perform a portion of autonomic management associated with a manageable entity that is also manageable by the autonomic manager.

5. The method of claim 4, wherein providing the interface comprises forming the interface to cause management by the manual manager to be indistinguishable from management by the autonomic manager.

6. The method of claim 1, further comprising allowing establishment of a balance between management by the manual manager and the autonomic manager.

7. The method of claim 1, further comprising permitting evaluation of a set of at least different circumstances, workloads, and policies to establish a balance between management by the manual manager and the autonomic manager.

8. The method of claim 1, further comprising using substantially similar interfaces and system flows for the manual manager and the autonomic manager.

9. The method of claim 8, further comprising using multiple modes of communication between the interfaces.

10. The method of claim 1, further comprising:
allowing disablement of at least a part of the autonomic manager from participation in management of a manageable entity; and
allowing performance of any operations of an autonomic computing process, not being performed by the autonomic manager, to be performed by the manual manager.

11. The method of claim 1, further comprising allowing partial delegation, wherein an autonomic computing architecture comprises at least one partial autonomic manager to collaborate on an entire autonomic computing process.

12. The method of claim 1, further comprising allowing management of the manual manager by at least one of another manual manager and another autonomic manager.

13. A system to share systems management responsibility, comprising:
a user interface to selectively perform a portion of autonomic management associated with a manageable entity that is also manageable by an autonomic manager, wherein a manual manager is formable as a manageable resource capable of being monitored and controlled; and
a manageability interface associated with the autonomic manager to permit the autonomic manager to be monitored and controlled.

14. The system of claim 13, further comprising at least one of:
means to assign a task to the autonomic manager;
means for the autonomic manager to request assistance;
means to oversee autonomic manager results;
means to take over a task performed by the autonomic manager;
means to participate in a partially autonomic system management configuration by participating in an autonomic computing architecture; and
a manageability interface associated with the manual manager to permit the manual manager to be monitored and controlled.

15. The system of claim 14, wherein the manual manager comprises a sensor interface and an effector interface to monitor and control the autonomic manager.

16. The system of claim 13, wherein the user interface is adapted to allow the autonomic manager to perform at least a portion of an autonomic computing process, wherein any operations not being performed by the autonomic manager are performable by a manual manager.

17. The system of claim 13, further comprising at least one partial autonomic manager to collaborate on an entire autonomic computing process.

18. A computer program product to share system management responsibility, the computer program product comprising:
a computer usable medium having computer usable program code embodied therein, the computer usable medium comprising:
computer usable program code configured to allow formation of a manual manager, wherein the manual manager is formable as a manageable resource capable of being monitored and controlled; and
computer usable program code configured to permit an autonomic manager to be monitored and controlled using a manageability interface of the autonomic manager.

19. The computer program product of claim 18, further comprising computer usable program code configured to at least one of:
allow assignment of a task to the autonomic manager;
allow the autonomic manager to request assistance;
permit oversight of autonomic manager results;
allow a task being performed by the autonomic manager to be taken over;
allow participation in a partially autonomic system management configuration; and
permit participation of the manual manager and the autonomic manager in an autonomic computing architecture, wherein the manual manager and the autonomic manager are adapted to be monitored and controlled using a respective manageability interface of the autonomic manager and the manual manager.

20. The computer program product of claim 18, further comprising computer usable program code configured to allow partial delegation, wherein an autonomic computing architecture comprises at least one partial autonomic manager to collaborate on an entire autonomic computing process.
